(19) United States
(12) Patent Application Publication
(10) Pub. No.: US 2016/0125786 A1
(43) Pub. Date: May 5, 2016

(54) OVER-DRIVING METHOD, CIRCUIT, DISPLAY PANEL AND DISPLAY APPARATUS

(71) Applicant: BOE TECHNOLOGY GROUP CO., LTD., Beijing (CN)

(72) Inventor: Yiqiang LAI, Beijing (CN)

(73) Assignee: BOE TECHNOLOGY GROUP CO., LTD., Beijing (CN)

(21) Appl. No.: 14/347,803

(22) PCT Filed: Apr. 27, 2013
(86) PCT No.: PCT/CN2013/074851

§ 371 Date: Mar. 27, 2014

(30) Foreign Application Priority Data
Mar. 12, 2013 (CN) 201310078617.0

(51) Int. Cl. G09G 3/20; G09G 3/00; G09G 3/36

(52) U.S. Cl. CPC G09G 3/2018; G09G 3/36; G09G 3/003; G09G 2320/0285; G09G 2320/0209; G09G 2310/027; G09G 2320/0252; G09G 2340/16

(57) ABSTRACT

An over-driving method, circuit, display panel and 3D display apparatus pertain to a field of 3D display. The over-driving method includes: acquiring an actual gray scale value outputted from any pixel in a previous frame; acquiring an original gray scale value to be outputted from the corresponding pixel in a current frame; and looking up an over-driving comparison table according to the actual gray scale value in the previous frame and the original gray scale value in the current frame, and determining an actual gray scale value that should be outputted in the current frame. The method can quicken the response speed of the liquid crystal and improve the phenomenon of crosstalk when being used in a 3D mode of shutter glasses.

### TECHNICAL FIELD

The present invention relates to a field of 3D display, and particularly to an over-driving method, circuit, display panel and 3D display apparatus.

### BACKGROUND

In a traditional TFT-LCD (Thin Film Transistor-Liquid Crystal Display), liquid crystal has a slow response speed during a G to G (Gray to Gray, gray scale conversion). The response speed of the liquid crystal is rapider when a change in a voltage difference for driving the liquid crystal is larger, therefore an Over Driving technique is generally utilized to quicken the response speed during the G to G in the prior art. This technique provides, when an image data changes, an actual data having a higher or lower gray scale than an original data during the first frame in which the data changes, thereby the driving voltage of the liquid crystal is increased, and the original data after the second frame is recovered. Since only the data in the first frame is changed by a timing control circuit (T-con), the display of the original normal image would not be affected.

A detailed implementation of the Over Driving technique is as follows: the T-con stores the image data of each frame into a memory, such as SDRAM (Synchronous Dynamic Random Access Memory), DDR (Double Data Rate, double data rate synchronous dynamic random access memory) and the like; when the image data changes, the T-con compares the original data in a current frame with that in a next frame or compares the original data in the current frame with that in the previous frame, looks up an over-driving comparison table by a manner of looking up a table (Look-Up Table LUT), and changes the actual data output of the image in the current frame. Herein the data in the over-driving LUT is set in advance and stored inside the T-con.

In the existing Over Driving technique, the image data of each frame is stored in the memory, and the original data in the current frame is compared with that in the previous frame when the image data changes, such that the data outputted to the display panel by the T-con is decided. All of the data stored in the memory is the original data, and thus what is compared during the comparison process is only the original data. In a 2D mode, the same image data may maintain at least two frames even if the image data is dynamic, and a point of time at which the Over Driving operation is performed is the first frame in which the change occurs, therefore it may be ensured that the data in the previous frame before the image data changes is the same as the original data outputted to the display panel, so that such manner for comparing the data is reasonable logically.

However, in a 3D mode of shutter glasses, the comparison manner in the existing Over Driving technique is unreasonable, because in the 3D mode of shutter glasses, an odd frame outputs a right eye data and an even frame outputs a left eye data, or the odd frame outputs the left eye data and the even frame outputs the right eye data, that is to say, the data in each frame is changing. The comparison manner in the existing Over Driving technique may lead to a problem of over-driving or under-driving, the gray scale to be displayed originally can not be reached and a phenomenon of crosstalk occurs.

### SUMMARY

A technical problem to be settled by the present disclosure is how to provide an over-driving method, circuit, display panel and display apparatus, which are capable of quickening the response speed of the liquid crystal in the 3D mode of shutter glasses thereby improving the phenomenon of crosstalk.

To solve the technical problem, exemplary embodiments of the present disclosure provide solutions as follows.

In an aspect, there is provided an over-driving method, comprising steps of:

acquiring an actual gray scale value outputted from any pixel in a previous frame;

acquiring an original gray scale value to be outputted from the corresponding pixel in a current frame; and

looking up an over-driving comparison table according to the actual gray scale value outputted from the any one pixel in the previous frame and the original gray scale value to be outputted from the corresponding pixel in the current frame, and determining an actual gray scale value that should be outputted in the current frame.

Optionally, in the above solution, over-driving values corresponding to values changing from initial gray scale value to object gray scale value are stored in the over-driving comparison table.

Optionally, in the above solution, the step of looking up an over-driving comparison table according to the actual gray scale value outputted from the any one pixel in the previous frame and the original gray scale value to be outputted from the corresponding pixel in the current frame and determining an actual gray scale value that should be outputted in the current frame comprises:

looking up the over-driving comparison table by regarding the actual gray scale value outputted from the any one pixel in the previous frame as the initial gray scale value and regarding the original gray scale value to be outputted from the corresponding pixel in the current frame as the object gray scale value, and regarding a corresponding over-driving value as the actual gray scale value that should be outputted in the current frame.

In another aspect, the exemplary embodiments of the present disclosure also provide an over-driving circuit, comprising:

a storage module for storing an actual gray scale value outputted from any pixel in a previous frame and an original gray scale value to be outputted from the corresponding pixel in a current frame; and

a gray scale voltage generation module for looking up an over-driving look-up table according to the actual gray scale value outputted from the any pixel in the previous frame and the original gray scale value to be outputted from the corresponding pixel in the current frame, and determining the actual gray scale value that should be outputted in the current frame.

Optionally, in the above solution, the storage module is further used for storing the over-driving comparison table, and over-driving values corresponding to values changing from initial gray scale value to object gray scale value are stored in the over-driving comparison table.

Optionally, in the above solution, the gray scale voltage generation module is used for looking up the over-driving comparison table by regarding the actual gray scale value outputted from the any one pixel in the previous frame as the initial gray scale value and regarding the original gray scale value to be outputted from the corresponding pixel in the current frame as the object gray scale value, and regarding a corresponding over-driving value as the actual gray scale value that should be outputted in the current frame.

According to the exemplary embodiments of the present disclosure, there is further provided a display panel comprising the over-driving circuit described above.

According to the exemplary embodiments of the present disclosure, there is further provided a display apparatus comprising the display panel described above.

The solutions according to the exemplary embodiments of the present disclosure may provide benefit effects as follows.

When the image data changes, the comparison manner is to compare the actual gray scale value actually outputted to the display panel in the previous frame and the original gray scale value expected to be outputted in the subsequent frame, so that not only the response speed of the liquid crystal can be quickened, but also a correct gray scale value can be ensured to be outputted to the display panel in the 3D mode of shutter glasses, thereby the problem of over-driving or under-driving may not occur and the phenomenon of 3D crosstalk is improved.

### BRIEF DESCRIPTION OF THE DRAWINGS

FIG. 1 is a schematic diagram illustrating a response time of the liquid crystal to which no over-driving technique is applied in the prior art;

FIG. 2 is a schematic diagram illustrating a response time of the liquid crystal to which the over-driving technique is applied in the prior art;

FIG. 3 is a schematic diagram illustrating a structure of a system for over-driving in the prior art;

FIG. 4 is a schematic diagram illustrating a flowchart of an over-driving method according to embodiments of the present disclosure; and

FIG. 5 is a schematic diagram illustrating a structure of an over-driving circuit according to embodiments of the present disclosure.

### DETAILED DESCRIPTION

Problems to be settled, solutions and advantages of the present disclosure will be more apparent from the following detailed description in conjunction with the accompanying drawings and detailed embodiments.

In order to settle the problem of the over-driving or the under-driving caused by the comparison manner in the existing over-driving method in the 3D mode of shutter glasses and the problem of crosstalk due to an un-reach of the gray scale that should be displayed, the exemplary embodiments of the present disclosure provide an over-driving method, circuit, display panel and display apparatus, which are capable of quickening the response speed of the liquid crystal and in turn improving the phenomenon of the crosstalk in the 3D mode of the shutter glasses.

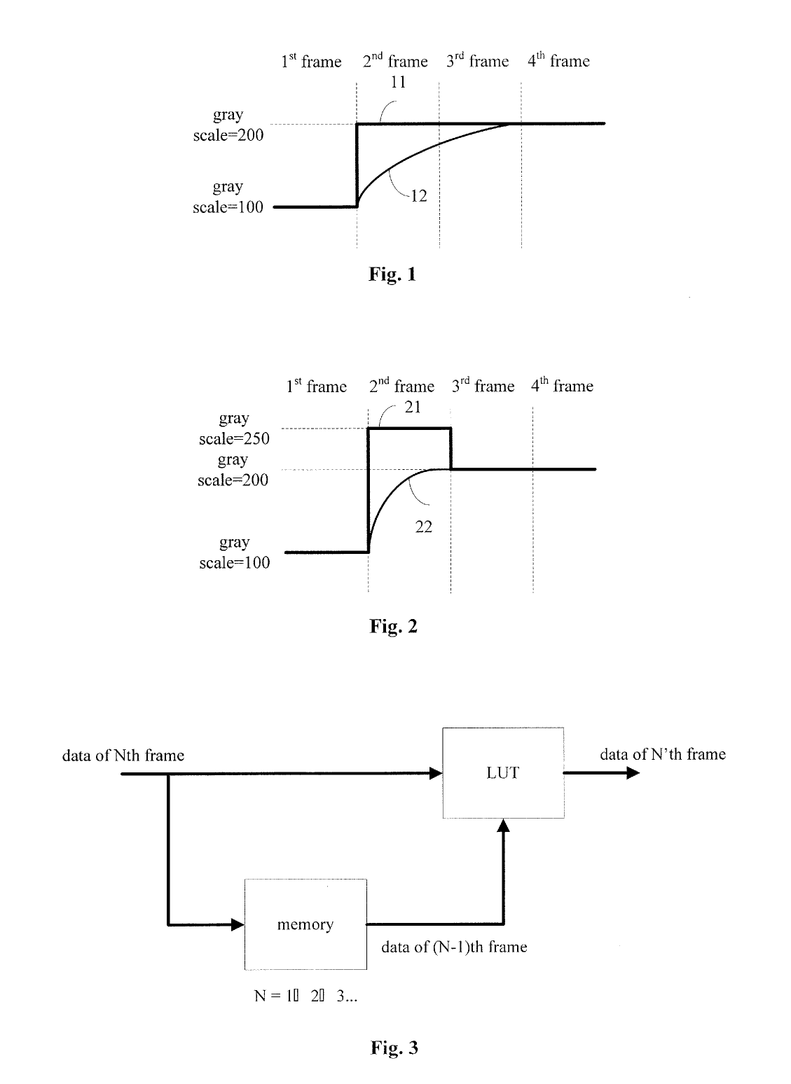

A specific implementation of the Over Driving technique is as follows: a timing control circuit (T-con) stores the image data of each frame into a memory (such as a SDRAM, a DDR and the like); when the image data changes, the T-con compares the image data in a current frame with that in a next frame or compares the image data in the current frame with that in the previous frame, and changes the output of gray scale value of the image in the current frame by a manner of a Look-Up Table (LUT). As illustrated in FIG. 1, the original image data changes from a gray scale 100 to a gray scale 200, wherein a reference number 11 denotes an ideal response time line of the liquid crystal, and a reference number 12 denotes an actual response curve of the liquid crystal. In order to increase the response speed of the liquid crystal, the over-driving technique is utilized, it may be known that the change from the gray scale 100 to the gray scale 200 corresponds to a gray scale 250 by looking up the table, wherein the gray scale 100 is an initial gray scale value, the gray scale 200 is an object gray scale value, and the gray scale 250 is an over-driving value corresponding to the value changing from the initial gray scale value to the object gray scale value. As illustrated in FIG. 2, the T-con may output at first the gray scale 250 in the first frame (that is, the 2^{nd} frame in the figure) during which the image data changes, and subsequently output the gray scale 200 of the original data, wherein a reference number 21 denotes an ideal response time line of the liquid crystal, and a reference number 22 denotes an actual response curve of the liquid crystal. It can be seen that the actual response curve 22 of the liquid crystal to which the over-driving technique is adopted is better than the actual response curve 12 of the liquid crystal to which no over-driving technique is adopted. Herein the data in the LUT is set in advance and is stored inside the T-con.

As illustrated in FIG. 3, in the existing Over Driving technique, the image data of each frame is stored in the memory, and when the image data changes, the original data in the current frame (that is, the Nth frame) is compared with that in the previous frame (that is, the (N−1)th frame), such that the gray scale values (that is, the data of N′th frame) outputted to the display panel by the T-con is decided. All of the data stored in the memory is the original data thereby all of the data compared during the comparison process is the original data. In a 2D mode, the same image data may maintain at least two frames even if the image data is dynamic, and a point of time at which the Over Driving operation is performed is the first frame in which the changes occurs thereby it may be ensured that the data in the previous frame when the image data changes is the same as the original data outputted to the display panel, so that such manner for comparing the data is reasonable logically. For example, when a change order of the original data is the gray scale 100→the gray scale 200→the gray scale 200→the gray scale 200→the gray scale 100→the gray scale 100, if a corresponding gray scale 250 is acquired for the change of the gray scale 100→the gray scale 200 by the LUT and a corresponding gray scale 50 is acquired for the change of the gray scale 200→the gray scale 100 by the LUT, the order of data outputted to the display panel, which is processed by the T-con, is the gray scale 100→the gray scale 250→the gray scale 200→the gray scale 200→the gray scale 50→the gray scale 100.

However, in the 3D mode of shutter glasses, the comparison manner in the existing Over Driving technique is unreasonable, because in the 3D mode of shutter glasses, an odd frame outputs a right eye data and an even frame outputs a left eye data, or the odd frame outputs the left eye data and the even frame outputs the right eye data, that is to say, the data in each frame is changing. For example, if the change order of the original data is the gray scale 100→the gray scale 200→the gray scale 100→the gray scale 200, the data outputted to the display panel would be the gray scale 100→the gray scale 250-the gray scale 50→the gray scale 250 in a case of the existing over-driving method. That is to say, when the 3^{rd} frame is to be outputted after the 2^{nd} frame is outputted, the gray scale outputted to the display panel by the 2^{nd} frame is the gray scale 250, the original data to be outputted in the 3^{rd} frame is the gray scale 100, at this time a gray scale corresponding to the change of the gray scale 200→the gray scale 100 should be looked up in the LUT according to the existing over-driving method, that is, the gray scale 50 is acquired, such that the output order is the gray scale 100→the gray scale 250→the gray scale 50→the gray scale 250. However, such comparison manner is unreasonable, may lead to a problem of over-driving or under-driving, and the original gray scale of the display can not be reached. In fact, at this time, a gray scale corresponding to the change of the gray scale 250→the gray scale 100 should be looked up in the LUT. That is to say, in the 3D mode of shutter glasses, when the image data changes, a correct comparison manner is to compare the gray scale value actually outputted to the display panel in the previous frame with the original gray scale value expected to be outputted in the subsequent frame, instead of comparing the original gray scale value in the previous frame with the original gray scale value expected to be outputted in the subsequent frame.

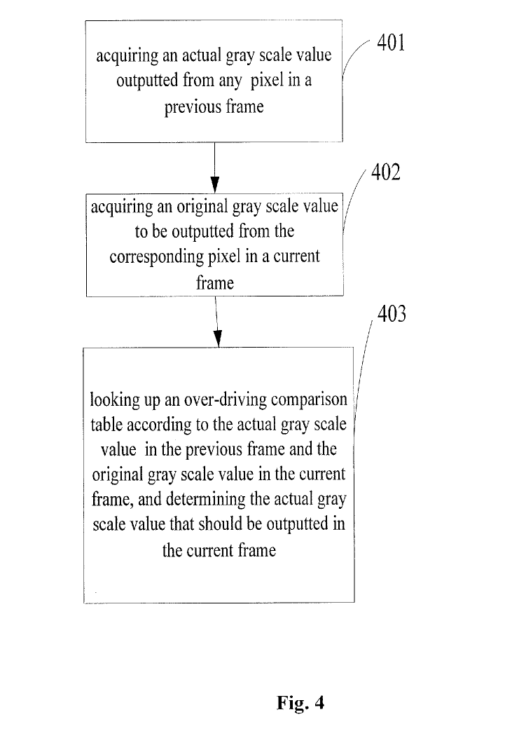

Therefore, the exemplary embodiments of the present disclosure provide an over-driving method, as illustrated in FIG. 4, the method comprises steps as follows:

step 401: acquiring an actual gray scale value outputted from any one pixel in a previous frame;

step 402: acquiring an original gray scale value to be outputted from the corresponding pixel in a current frame; and

step 403: looking up an over-driving look-up table according to the actual gray scale value outputted from the any pixel in the previous frame and the original gray scale value to be outputted from the corresponding pixel in the current frame, and determining an actual gray scale value that should be outputted in the current frame.

In an example, over-driving values corresponding to values changing from initial gray scale value to object gray scale value are stored in the over-driving look-up table.

In an example, the step 403 may further comprise:

looking up the over-driving table by regarding the actual gray scale value outputted from the any one pixel in the previous frame as the initial gray scale value and regarding the original gray scale value to be outputted from the corresponding pixel in the current frame as the object gray scale value, and regarding a corresponding over-driving value as the actual gray scale value that should be outputted in the current frame.

In the over-driving method according to the exemplary embodiments of the present disclosure, when the image data changes, the comparison manner is to compare the gray scale value actually outputted in the previous frame and the original gray scale value expected to be outputted in the subsequent frame, so that not only the response speed of the liquid crystal may be quickened, but also a correct gray scale value may be ensured to be outputted to the display panel in the 3D mode of shutter glasses thereby the problem of over-driving or under-driving may not occur and the phenomenon of 3D crosstalk is improved.

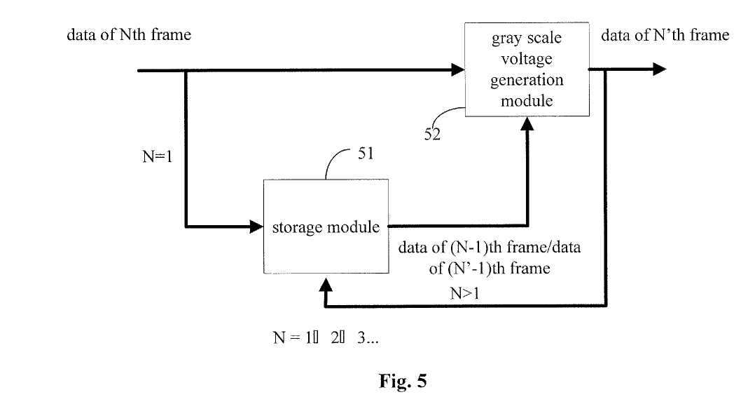

The exemplary embodiments of the present disclosure further provide an over-driving circuit, as illustrated in FIG. 5, the over-driving circuit comprises:

a storage module 51 for storing an actual gray scale value outputted from any pixel in a previous frame and an original gray scale value to be outputted from the corresponding pixel in a current frame; and

a gray scale voltage generation module 52 for looking up an over-driving comparison table according to the actual gray scale value in the previous frame and the original gray scale value in the current frame, and determining an actual gray scale value that should be outputted in the current frame.

Alternatively, the storage module 51 further stores the over-driving look-up table, and over-driving values corresponding to values changing from initial gray scale value to object gray scale value are stored in the over-driving look-up table.

The gray scale voltage generation module 52 may be used for looking up the over-driving comparison table by regarding the actual gray scale value outputted in the previous frame as the initial gray scale value and regarding the original gray scale value to be outputted in the current frame as the object gray scale value, and regarding a corresponding over-driving value as the actual gray scale value that should be outputted in the current frame.

In the over-driving circuit according to the exemplary embodiments of the present disclosure, when the image data changes, the comparison manner is to compare the gray scale value actually outputted in the previous frame and the original gray scale value expected to be outputted in the subsequent frame, so that not only the response speed of the liquid crystal may be quickened, but also a correct gray scale value may be ensured to be outputted to the display panel in the 3D mode of shutter glasses thereby the problem of over-driving or under-driving may not occur and the phenomenon of 3D crosstalk is improved.

The over-driving method and circuit of the display panel according to the exemplary embodiments of the present disclosure will be described in details below in connection with FIG. 5.

As illustrated in FIG. 5, as identical as the prior art, the original gray scale values of the 1^{st} frame may be stored in the storage module 51, and after the 2^{nd} frame, what are stored in the storage module 51 are not only the original gray scale values but also the gray scale values actually outputted to the display panel. When the image data changes, the original gray scale value of any one pixel in the current frame (that is, the data in the Nth frame) is compared with the gray scale value actually outputted to the display panel of the corresponding pixel in the previous frame (that is, the data in the (N′−1)th frame), so that the gray scale value outputted to the display panel by the T-con of the pixel in the current frame (that is, the data of the N′th frame), is decided, where N>1. In other words, before the gray scale values in the 2^{nd} are outputted, the original gray scale values in the 2^{nd} frame are compared with the actual gray scale values in the 1^{st} frame, and the data of the 2′^{nd} frame is outputted by looking up the look-up table (LUT); before the gray scale values in the 3^{rd} frame are outputted, the original gray scale values in the 3^{rd} frame are compared with the actual gray scale values in the 2′^{nd} frame, and the gray scale values of the 3′^{rd} frame is outputted by looking up the look-up table (LUT); and so on. In the solutions according to the embodiments of the present disclosure, when the image data changes, the comparison manner is to compare the gray scale value actually outputted to the display panel in the previous frame and the original gray scale value expected to be outputted in the subsequent frame, so that not only the response speed of the liquid crystal may be quickened, but also a correct gray scale value can be ensured to be outputted to the display panel in the 3D mode of shutter glasses thereby the problem of over-driving or under-driving may not occur and the phenomenon of 3D crosstalk is improved.

The exemplary embodiments of the present disclosure further provide a display panel comprising the circuit over-driving described above.

The exemplary embodiments of the present disclosure further provide a display apparatus comprising the display panel described above. The display apparatus may be a mobile phone, a tablet computer, a TV, a display, a notebook computer, a digital photo frame, a navigation instrument, or any other products or parts having a display function.

Many functional parts described in the present specification are referred to as modules, in order to emphasize particularly the independences of their implementations.

In the embodiments of the present disclosure, the module may be realized by software, in order to be performed by various types of processors. For example, an identified executable code module may include one or more physical or logical blocks of computer instructions, for example, it may be constructed as an object, a procedure or a function. Even so, the executable codes of the identified module are not necessary in together physically, but may include different instructions stored in different physical positions, and when these instructions are logically combined, they construct the modules and realize the specified purpose of the modules.

In fact, the executable code modules may be a single instruction or a plurality of instructions, and even may be distributed over a plurality of different code segments, over different programs, and across multiple memory equipments. Similarly, operation data may be identified inside a module, and may be realized in accordance with any appropriate forms and be organized in any data structure of an appropriate type. The operation data may be collected as a single data set, or may be distributed at different positions (being included on different storage devices), and at least partially may be existed in a system or a network only as electronic signals.

When the module may be realized by the software, taking the existing hardware state of technology into account, those skilled in the art may establish a corresponding hardware circuit for the module capable of being realized by the software to realize the corresponding function in a case that no cost is considered, and the hardware circuit may comprise a conventional VLSI or a gate array and existing semiconductor components, such as a logic chip, a transistor, or other discrete components. The module may also be realized by programmable hardware devices, such as a field programmable gate array, programmable array logic, programmable logic device and the like.

In the process embodiments of the present disclosure, the numbers of the respective steps do not intend to limit the sequence of the respective step, and order changes of the respective steps also fall into the scope sought for protection of the present disclosure.

Above are the exemplary embodiment of the disclosure, it will be obvious to those skilled in the art that many enhancements and variations may be made without departing from the principle of the present disclosure, and all such enhancements and variations are intended to be included within the scope sought for protection of the present disclosure.

1-8. (canceled)

9. An over-driving method, comprising steps of:
acquiring an actual gray scale value outputted from any pixel in a previous frame;
acquiring an original gray scale value to be outputted from the corresponding pixel in a current frame; and
looking up an over-driving comparison table according to the actual gray scale value outputted from the any one pixel in the previous frame and the original gray scale value to be outputted from the corresponding pixel in the current frame, and determining an actual gray scale value to be outputted in the current frame.

10. The over-driving method of claim 9, wherein over-driving values corresponding to values changing from initial gray scale value to object gray scale value are stored in the over-driving comparison table.

11. The over-driving method of claim 10, wherein the step of looking up an over-driving comparison table according to the actual gray scale value outputted from the any one pixel in the previous frame and the original gray scale value to be outputted from the corresponding pixel in the current frame and determining an actual gray scale value to be outputted in the current frame comprises:
looking up the over-driving comparison fable by regarding the actual gray scale value outputted from the any pixel in the previous frame as the initial gray scale value and regarding the original gray scale value to be outputted from the corresponding pixel in the current frame as the object gray scale value; and regarding a corresponding over-driving value as the actual gray scale value that should be outputted in the current frame.

12. An over-driving circuit, comprising:
a storage module for storing an actual gray scale value outputted from any pixel in a previous frame and an original gray scale value to be outputted from the corresponding pixel in a current frame; and
a gray scale voltage generation module for looking up an over-driving comparison table according to the actual gray scale value outputted from the any pixel in the previous frame and the original gray scale value to be outputted from the corresponding pixel in the current frame, and determining an actual gray scale value to be outputted in the current frame.

13. The over-driving circuit of claim 12, wherein
the storage module is further used for storing the over-driving comparison table in which over-driving values corresponding to values changing from initial gray scale value to object gray scale value are stored.

14. The over-driving circuit of claim 13, wherein
the gray scale voltage generation module is used for looking up the over-driving comparison table by regarding the actual gray scale value outputted from the any pixel in the previous frame as the initial gray scale value and regarding the original gray scale value to be outputted from the corresponding pixel in the current frame as the object gray scale value; and regarding a corresponding over-driving value as the actual gray scale value that should be outputted in the current frame.

15. A display panel comprising an over-driving circuit, which comprises
a storage module for storing an actual gray scale value outputted from any pixel in a previous frame and an original gray scale value to be outputted from the corresponding pixel in a current frame; and
a gray scale voltage generation module for looking up an over-driving comparison table according to the actual gray scale value outputted from the any pixel in the previous frame and the original gray scale value to be outputted from the corresponding pixel in the current frame, and determining an actual gray scale value to be outputted in the current frame.

16. The display panel of claim 15, wherein
the storage module is further used for storing the over-driving comparison table in which over-driving values corresponding to values changing from initial gray scale value to object gray scale value are stored.

17. The display panel of claim 16, wherein
the gray scale voltage generation module is used for looking up the over-driving comparison table by regarding the actual gray scale value outputted from the any pixel in the previous frame as the initial gray scale value and regarding the original gray scale value to be outputted from the corresponding pixel in the current frame as the object gray scale value; and regarding a corresponding over-driving value as the actual gray scale value that should be outputted in the current frame.

18. A display apparatus comprising the display panel of claim 15.

19. The display apparatus of claim 18, wherein
the storage module is further used for storing the over-driving comparison table in which over-driving values corresponding to values changing from initial gray scale value to object gray scale value are stored.

20. The display apparatus of claim 19, wherein
the gray scale voltage generation module is used for looking up the over-driving comparison table by regarding the actual gray scale value outputted from the any pixel in the previous frame as the initial gray scale value and regarding the original gray scale value to be outputted from the corresponding pixel in the current frame as the object gray scale value; and regarding a corresponding over-driving value as the actual gray scale value that should be outputted in the current frame.
